(19) United States
(12) Patent Application Publication
(10) Pub. No.: US 2017/0015578 A1
(43) Pub. Date: Jan. 19, 2017

(54) METHOD FOR TREATING ORGANIC WASTE BY HYDROTHERMAL OXIDATION

(71) Applicant: INNOVEOX, Paris (FR)

(72) Inventors: Grégoire Sarrail, Paris (FR); Carine Richer, Paris (FR); Mathieu Chaillou, Paris (FR)

(73) Assignee: INNOVEOX, Paris (FR)

(21) Appl. No.: 15/124,558

(22) PCT Filed: Mar. 10, 2015
(86) PCT No.: PCT/EP2015/054949

§ 371 Date: Sep. 8, 2016

(30) Foreign Application Priority Data
Mar. 10, 2014 (FR) 1451955

(51) Int. Cl. C02F 11/08; B01J 3/00; B01F 17/00; C02F 1/72; C02F 1/74

(52) U.S. Cl. CPC C02F 11/086; C02F 1/727; C02F 1/74; B01F 17/0078; B01F 17/0021; B01F 17/0028; B01F 17/0085; B01J 3/006; B01J 3/008; C02F 2305/04; C02F 2209/08; C02F 2101/32

(57) ABSTRACT

The present invention relates to a method for treating waste comprising at least one organic phase, said method comprising the following consecutive steps: a) preparation of an oil-in-water emulsion with controlled TOD using waste to be treated comprising at least one organic phase, by mixing said waste with an aqueous phase in a mixer, preferably with high shear; b) possible adjustment of the TOD of the emulsion obtained in step a); and c) hydrothermal oxidation, under subcritical or supercritical starting conditions, of the emulsion thus obtained. The present invention also relates to a facility suitable for implementing the method for treating waste comprising at least one organic phase according to the invention.

### FIELD OF THE INVENTION

The present invention relates to the field of treating organic wastes by hydrothermal oxidation.

### STATE OF THE ART

Multiple methods for treating aqueous effluents comprising organic wastes and/or dissolved salts have been described, among which mention may in particular be made of those in which the effluent to be treated is placed in the presence of an oxidizing agent under so-called “hydrothermal” conditions, which leads to oxidation of the wastes. In particular, the treatment of aqueous effluents at a temperature and at a pressure in which the water is found in a sub-critical or supercritical condition (the critical point of water being located at a temperature of 374 degrees Celsius and at a pressure of 221 bars), is known.

In the case of organic compounds, the treatment typically leads to oxidation in the form of simple compounds such as CO₂ and H₂O. The salts of metals other than alkaline and earth-alkaline metals are as for them typically converted into metal (hydr)oxides.

Document WO 89/08614 notably describes such a method of treatment by hydrothermal oxidation.

Another method of this type, which proves to be particularly interesting, is described in documents WO 2012/095391 or WO 02/20414, which gives the possibility of controlling the rise in temperature produced during hydrothermal oxidation. In the method described in these documents, the effluent is treated within a tubular reactor by introducing the oxidizing agent not in a single go but gradually along the tubular reactor, in several injection points along the path of the effluent, which gives the possibility of gradually increasing the temperature of the flow according to an increasing curve, from an initial sub-critical temperature (for example of the order of room temperature or above) up to a supercritical temperature. In this way, the oxidation of the organic compounds contained in the effluent is gradually achieved during its flow and the heat energy produced during the oxidation reaction at each injection is used for having the reaction mixture gradually pass form a sub-critical condition in a liquid phase to a supercritical condition.

The oxidation reaction produces a large amount of heat energy in the areas where the oxidizer concentration is the highest, i.e. in the areas for injecting the oxidizer. The occurrence of these hot areas may damage the walls of the reactor. It is therefore desirable to control this release of heat energy.

This is the reason why the effluents are generally characterized by their heat power (HP). The heat power of a fuel is the combustion reaction enthalpy per unit mass under normal conditions of temperature and pressure. In other words, the HP represents the energy released as heat by the combustion reaction with dioxygen. The HP is generally expressed in kilojoules per kilogram (noted as kJ/kg or kJ·kg⁻¹). However, for a given effluent, this energy release may be estimated by a measurement of the Chemical Oxygen Demand (COD). Indeed, COD analysis measures the amount of oxidizable material present in the effluent, or for identical compounds, the more concentrated the oxidizable material, the higher the heat power is. In a continuous industrial conduction, the effluents are characterized by their TOD (Total Oxygen Demand), the value of which is very close experimentally to COD, and has faster measurement times.

The optimum field of use of hydrothermal oxidation, i.e. allowing an efficient and secure application of the method without any risk of run-off of the reaction, is located at TODs of the effluent to be treated for example comprised between 20 and 400 g/L, preferably between 100 and 250 g/L, still more preferably between 150 and 220 g/L.

However the problem arises during the treatment of wastes comprising at least one organic phase, which cannot be treated alone neither by incineration or by biological degradation, or by hydrothermal oxidation as such. Thus, when the waste to be treated comprising at least one organic phase either consists of a single organic phase (single-phase waste), or at least a biphasic waste comprising insoluble aggregates with an average or apparent diameter of more than 1 mm or 5 mm, the waste is particularly difficult to treat in so far that the TOD is not homogenous within the latter. Indeed, very high TOD areas are observed (organic phase), and optionally low TOD areas (aqueous phase). Direct treatment by hydrothermal oxidation generates technical difficulties since “hot points” are formed which may cause run-off of the reaction.

Documents WO 89/08614, WO 2012/095391 and WO 02/20414 do not mention this technical problem.

A solution at a pilot scale of this problem is described in patent application EP 1 834 928 and in the article of Sanchez-Oneto et al. “Direct injection of oil waste in a supercritical water oxidation reactor at a pilot plant scale” (Proceedings of 11th European Meeting on Supercritical Fluids 2008). The latter consists in the use of a quasi-anhydrous organic waste for enriching a supercritical aqueous phase, said aqueous phase having a low TOD and comprising hydrogen peroxide for accelerating the oxidation reaction. Such a method gives the possibility of overcoming the problems related to low solubility of the organic waste to be treated in the aqueous phase, since the waste is injected in the supercritical aqueous phase, i.e. under conditions wherein the latter is soluble in the aqueous phase. Moreover, these documents provide, in the case of a rise in pressure or in temperature in the hydrothermal oxidation reactor, cutting off the supply of anhydrous organic waste.

Thus, the method according to application EP 1 834 928 or according to Sanchez-Oneto et al. involves the injection of the waste into the aqueous phase under supercritical conditions, which requires the use of expensive facilities, and especially facilities suitable for this purpose. Further, this method does not allow application within the scope of hydrothermal oxidation under sub-critical starting conditions.

Therefore, there is a need for an industrial method for treating wastes comprising at least one organic phase, optimized in terms of cost, yield and safety, and allowing specific control of the TOD of the effluent introduced into the hydrothermal oxidation reactor, notably under sub-critical starting conditions, which would allow a highly substantial gain in operational energy costs of the method. Such a method would give the possibility of not having to modify pre-existing facilities suitable for treatment by hydrothermal oxidation.

### SUMMARY OF THE INVENTION

The applicant solved this technical problem by applying a step of preparing an oil-in-water emulsion with a controlled TOD from a waste comprising at least one organic phase, before applying the hydrothermal oxidation step.

An aspect of the present invention thus relates to a method for treating wastes comprising at least one organic phase, said method comprising the following successive steps:

a) preparing an oil-in-water emulsion with a controlled TOD from a waste to be treated comprising at least one organic phase, by mixing in a mixer, preferably with high shear, said waste with an aqueous phase;

b) optionally adjusting the TOD of the emulsion obtained in step a);

c) hydrothermal oxidation under sub-critical or supercritical starting conditions of the thereby obtained emulsion,

the waste to be treated comprising at least one organic phase:
either consisting of a single organic phase (single-phase waste),
or being a multiphase (at least biphasic) waste comprising at least one organic phase, appearing in a decanted form or as an emulsion comprising aggregates or drops with an average or apparent diameter greater than 1 mm, preferably greater than 5 mm.

Another aspect of the present invention also relates to a facility suitable for applying the method according to the invention, comprising:
a mixer (1), preferably with high shear, adapted for receiving an aqueous phase and the waste to be treated in order to prepare the emulsion; and
a hydrothermal oxidation reactor (6), preferably a tubular reactor and comprising several points for injecting the oxidizer, for achieving the hydrothermal oxidation of the emulsion under sub-critical or supercritical starting conditions.

### PRESENTATION OF THE DRAWINGS

FIG. 1 is a schematic illustration of a facility suitable for applying an advantageous embodiment of the method according to the invention.

### DEFINITIONS

By “oil-in-water emulsion”, is meant in the sense of the present invention an at least biphasic composition comprising a continuous phase and at least one discontinuous phase, the continuous phase being of an aqueous nature, and the discontinuous phase essentially being of an organic nature. According to an alternative, the emulsion is biphasic.

In the sense of the present invention, by “waste to be treated comprising at least one organic phase” is meant a waste which either consists of a single organic phase (single-phase waste), or at least a biphasic waste comprising at least one organic phase. A multiphase waste comprising at least one organic phase for example appears in a decanted form or as an emulsion comprising aggregates or macroscopic drops, i.e. for which the average or apparent diameter is greater than 1 mm, preferably greater than 5 mm.

By “organic phase”, is meant in the sense of the present invention, a phase non-miscible with water, which for example appears in a decanted form or as aggregates or macroscopic drops, i.e. for which the average or apparent diameter is greater than 1 mm, preferably greater than 5 mm. The organic phase preferably essentially comprises organic constituents (optionally mixed with inorganic material), and is present at a concentration which exceeds its saturation concentration in water. The organic phase is therefore distinct from the aqueous phase, which itself essentially consists of water, optionally mixed with inorganic material (preferably soluble material). The organic phase therefore forms the discontinuous phase of the oil-in-water emulsion.

In the sense of the present invention, by “TOD” or “total oxygen demand” are meant the O₂ (dioxygen) mass necessary for carrying out complete oxidation of one liter of organic waste, and/or inorganic waste, i.e. the total decomposition of the waste into CO₂ and H₂O, etc . . . under thermal oxidation conditions. The TOD is expressed in g/L. The measurement of TOD may notably be carried out according to the following procedure. A sample volume of the effluent to be analyzed is introduced into an oven at 1,200° C. for example, wherein circulates a controlled flow of O₂ gas. This oxygen flow is measured at the outlet of the oven, for example by means of a zirconium detector. The thermal oxidation of the effluent in the oven is assumed to be total at this temperature, and causes a reduction in the oxygen flow measured at the outlet. The measurement of the consumed oxygen flow by the reaction gives the possibility of expressing TOD in g of O₂ per litre of waste.

The term “COD” or “chemical oxygen demand” will also be mentioned, which in the sense of the present invention is defined as being the mass of O₂ necessary for carrying out complete oxidation of one liter of organic, and/or inorganic waste, i.e. the total decomposition of the waste into CO₂ and H₂O, etc . . . under chemical oxidation conditions. The measurement of the COD may notably be carried out by means of a usual COD-metre, for example as described in the NFT90-101 and ISO15705 standards. The measurement of COD may notably be carried out according to the following procedure. A sample volume of the effluent to be analyzed is introduced into a commercial tube comprising potassium dichromate, and then the tube is introduced into an oven at 148° C. for two hours. The tube is then extracted from the oven, and a colorimetric measurement at the wavelength of 605 nm is carried out. The COD-meter, which is calibrated, directly gives a COD value by correlation with the measured absorbence value.

In a continuous industrial conduction, the effluents are characterized by their TOD (Total Oxygen Demand), the value of which is experimentally very close to COD. Generally, a difference of at most 5% is observed between the measured TOD and COD values.

By “hydrothermal oxidation (HTO) under supercritical starting conditions”, is meant in the sense of the present invention that the hydrothermal oxidation is conducted as soon as the input of the reactor under pressure and temperature conditions such that the water, which is the solvent of the reaction and therefore the majority constituent of the reaction mixture, is in the form of a supercritical fluid. The supercritical point of water corresponds to the temperature of about 374° C. at a pressure of about 221 bars. Typically, the initial temperature of the effluent at the inlet of the reactor in which takes place the hydrothermal oxidation is preferably comprised between 374° C. and 600° C., and at a pressure comprised between 221 and 300 bars.

By “hydrothermal oxidation (HTO) under sub-critical starting conditions”, is meant in the sense of the present invention that the hydrothermal oxidation is conducted according to a method in which the effluent (comprising the waste to be treated) is treated inside a reactor by introducing the oxidizer in at least one injection point, which gives the possibility of increasing the temperature of the effluent, from a sub-critical initial temperature up to a higher sub-critical temperature or supercritical temperature. Typically, the initial sub-critical temperature of the effluent at the inlet of the reactor in which the hydrothermal oxidation takes place is preferably comprised between 20° C. and 373° C., still more preferably comprised between 150° C. and 350° C., still more preferably comprised between 250° C. and 350° C., and at a pressure comprised between 1 and 300 bars, preferably comprised between 15 bars and 300 bars, still preferably between 15 bars and 250 bars, still preferably among all values between 221 and 250 bars. The hydrothermal oxidation step under sub-critical starting conditions according to the invention is preferably carried out according to a continuous method. Advantageously the reactor used is a tubular reactor as described in WO 02/20414.

### DETAILED DESCRIPTION OF THE INVENTION

The present invention first relates to a method for treating wastes comprising at least one organic phase, said method comprising the following successive steps:

a) preparation of an oil-in-water emulsion with a controlled TOD from a waste to be treated comprising at least one organic phase, for example in a mixer, preferably with high shear, of said waste with an aqueous phase;

b) optionally adjustment of the TOD of the emulsion obtained in step a);

c) hydrothermal oxidation under sub-critical or supercritical (preferably sub-critical) starting conditions of the thereby obtained emulsion.

By “high shear mixer” is meant in the sense of the present invention a mixer capable of mixing two non-miscible liquids with possibly different viscosities with a sufficient shear rate for forming an emulsion, as opposed to a low shear mixer which does not allow such mixing. As an example, mention will notably be made of high shear mixers of the brand SILVERSON®.

The waste to be treated comprising at least one organic phase:
either consists of a single organic phase (single-phase waste),
or is a multiphase (at least biphasic) waste comprising at least one organic phase, appearing in a decanted form or as an emulsion comprising aggregates or drops with an average or apparent diameter greater than 1 mm, preferably greater than 5 mm.

According to an alternative of the invention, the waste to be treated is a single phase waste, and therefore comprises a single organic phase, optionally mixed with inorganic material, such as inorganic salts (mineral or metal salts).

The waste comprising at least one organic phase is preferably selected from petroleum residues or residues from the chemical industry. Mention may notably be made of bitumens, tars, effluents of the used lubricating oil type, organic solvents. Said waste may have very strong viscosity.

The TOD of the oil-in-water emulsion obtained at the end of step b), and used for applying the step c), is for example comprised between 20 and 400 g/L, preferably comprised between 100 and 250 g/L, still preferably comprised between 150 and 220 g/L. TOD values of less than 400 g/L give the possibility of avoiding a too large increase in the temperature within the reactor during the HTO, which may lead to damaging the latter. Step c) is then conducted under conditions giving the possibility of ensuring total safety of the method, and of increasing the lifetime of the pieces of equipment used for applying step c). Further, TOD values of more than 100 g/L generally give the possibility of making the hydrothermal oxidation method autothermal, the oxidation reaction producing sufficient heat for sustaining itself, and the residual heat may advantageously be recycled into other steps of the method or another industrial process, or reused for producing electricity. Thus, by controlling the TOD of the emulsion used for applying step c) it is both possible to optimize the safety and the energy cost of the method.

Step a) is advantageously conduced at atmospheric pressure and at room temperature. These reaction conditions allow reduction in the energy costs of the method.

Advantageously, the aqueous phase essentially consists of water. It may nevertheless comprise between 1 and 30% of additives such as alcohols or sugars. Preferably, the aqueous phase does not contain any hydrogen peroxide.

In an embodiment of the invention, a surfactant is used in the aqueous phase in order to stabilize the emulsion. Thus, the aqueous phase of the emulsion in step a) comprises at least one surfactant, representing less than 10% by weight, for example from 0.1 to 10% by weight, based on the total weight of the aqueous phase.

It should be noted that the use of a surfactant is not necessary for obtaining an emulsion from the waste to be treated, the latter may comprise constituents playing the role of surfactants. Nevertheless, for the treatment of certain wastes, it seems preferable to use a surfactant. The latter may be of an anionic, cationic or non-ionic nature. One skilled in the art will know how to adapt the selection of the surfactant to the particular nature of the waste to be treated.

However, preferably, the surfactant used in this embodiment is non-ionic. In particular, polysorbates and nonylphenol ethoxylates have emulsifier and heat resistance properties which are particularly advantageous for applying step a). Thus, the surfactant according to the present invention is preferably selected from among polysorbates and nonylphenol ethoxylates.

By polysorbates, are meant preferably pegylated derivatives of sorbitan, i.e. sorbitan derivatives comprising several polyoxyethylene chains and esterified by a fatty acid. Polysorbates are well known to one skilled in the art. Preferably, the polysorbates comprise between 10 and 50 oxyethylene units —(CH₂CH₂O)—, still preferably between 15 and 30 oxyethylene units —(CH₂CH₂O)—, still preferably 20 oxyethylene units —(CH₂CH₂O)—. Mention may notably be made of Polysorbate 20 or TWEEN® 20 (polyoxyethylene (20) sorbitan monolaurate, CAS 9005-64-5), Polysorbate 40 or TWEEN® 40 (polyoxyethylene (20) sorbitan monopalmitate, CAS 9005-66-7), Polysorbate 60 or TWEEN® 60 (polyoxyethylene (20) sorbitan monostearate, CAS 9005-67-8), and Polysorbate 80 or TWEEN® 80 (polyoxyethylene (20) sorbitan monooleate, CAS 9005-65-6). Preferably, the polysorbate used is Polysorbate 80 or TWEEN® 80.

Among the nonylphenol ethoxylates, will be preferred nonylphenol ethoxylates which comprise between 10 and 50 oxyethylene units —(CH₂CH₂O)—, still preferably between 15 and 30 oxyethylene units —(CH₂CH₂O)—, preferably 20 oxyethylene units —(CH₂CH₂O)—. For example, mention may be made of the products marketed under the brand of Tergitol NP® or Tergitol 15-S®.

The non-ionic surfactant preferably represents from 0.1 to 10% by weight, preferably between 0.1 to 5% by weight, still more preferably from 0.1% to 1% by weight based on the total weight of the aqueous phase.

In a preferred embodiment, the non-ionic surfactant is mixed with the aqueous phase. The aqueous phase comprises from 0.1 to 10% by weight, based on the total weight of the aqueous phase, of at least one non-ionic surfactant. And the waste to be treated comprising at least one organic phase is then gradually incorporated into said aqueous phase comprising the non-ionic surfactant into a mixer, leading to the formation of the oil-in-water emulsion. Preferably, the mixer is a high shear mixer. In this case, the waste to be treated comprising at least one organic phase and the aqueous phase comprising the non-ionic surfactant are mixed for a duration of less than 24 h, preferentially less than 12 h, preferentially for about 1 h.

Optionally, the method according to the invention comprises a step b) for adjusting the TOD. The adjustment of the TOD may be obtained:
if the measured TOD of the emulsion from step a) is too high: by dilution, for example by adding water or another effluent with a lower TOD; and
if the measured TOD of the emulsion from step a) is too low: by concentration, for example by adding organic and/or inorganic wastes or an effluent with a higher TOD into the effluent to be treated, preferably of said waste comprising at least one organic phase, or by adding a soluble organic additive into the continuous, generally alcohols, in particular linear or branched C₁-C₈ alcohols, or sugars such as glucose.

By “linear or branched C₁-C₈ alcohol”, is meant in the sense of the present invention a linear or branched alkyl comprising at least one alcohol function (OH). For example mention will be made of methanol, ethanol, n-propanol, isopropanol, n-butanol, sec-butanol, tert-butanol, pentanol, hexanol, heptanol, and octanol. In particular, isopropanol will be considered.

Typically, for applying step b), sampling of the emulsion obtained at the end of step a) is carried out and measurement of the TOD of this sample is conducted. It is observed that the location of the sampling on the mixing system has no impact on the TOD measurement. Depending on the obtained TOD result, i.e.:
if the measured TOD is comprised in the set value window, the effluent is sent into a storage tank, either in the hydrothermal oxidation reactor by suitable supply means notably comprising a supply pump, and optionally including a system for heating the emulsion;
if the TOD is greater than the upper limit of the set value window, water or another less concentrated aqueous effluent is added, preferably water, optionally obtained at the end of step c) and recycled;
if the TOD is less than the low limit of the set value window, an organic and/or inorganic waste or a more concentrated effluent is added into the emulsion, preferably this is the said waste comprising at least one organic phase.

Preferably, steps a) and b) are conducted according to a batch-wise or discontinuous method (still called a batch method). In this embodiment, the emulsion obtained at the end of step a) or b) is typically sent into a storage tank, which gives the possibility of supplying the reactor for applying step c).

According to an alternative, the emulsion obtained at the end of step a) or b) comprises between 5 and 50% by weight, preferably between 15 and 45% by weight, still more advantageously between 25 and 35% by weight of an organic phase based on the total weight of the emulsion. The remainder of the emulsion consists of the aqueous phase, and optionally of at least one surfactant, notably a non-ionic surfactant, and/or of additives.

The emulsion obtained at the end of step a) or b) is advantageously homogenous. In particular, the TOD of the emulsion is homogeneous at a macroscopic scale. In other words, the distribution of the drops in the emulsion is homogeneous.

Thus, the emulsion obtained at the end of step a) or b) advantageously has an average drop size of less than 1,000 μm, preferably between 0.1 and 100 μm, still preferably between 0.5 and 10 μm, still preferably between 0.5 and 5 μm. By “average drop size” is meant in the sense of the present invention both the average diameter of the drops of a discontinuous phase, and the apparent diameter of the possible aggregates. By “aggregate”, is mean in the sense of the present invention an assembly of several drops connected together but not merged.

These average drop size ranges and the homogeneity of said emulsion are particularly advantageous in so far that they give the possibility of not obtaining a too high local concentration of organic phase, which would be deleterious to the application of the hydrothermal oxidation (HTO) step c). They also improve the safety of the hydrothermal oxidation method by preventing the formation of organic aggregates which may upon contact with oxygen (O₂), lead to a violent exothermic reaction generating a rise in temperature detrimental to the mechanical strength of the reactor(s) (better management of the exothermicity of the oxidation reaction).

Thus, step a) of forming the oil-in-water emulsion is essential for treating wastes to be treated comprising at least one organic phase according to present invention, since it gives the possibility of both reducing the TOD of waste to be treated, and to increase the homogeneity of the TOD within the latter.

Further, the emulsion obtained at the end of step a) or b) is advantageously stable for a period comprised between 1 hour and 24 hours, preferably between 1 hour and 3 days, still more preferably between 1 and 7 days. The sought minimum stability period is defined by the dwelling time of the emulsion between the storage tank and the inlet of the hydrothermal oxidation reactor. This stability is therefore notably observed at temperatures comprised between 15° C. and 374° C., and at pressures comprised between 1 and 300 bars. It will be noted that the turbulences accompanying the flow of the emulsion in the facilities participate in the preservation of the stability.

By “stable”, is meant that the homogeneity properties, of the average drop size and of the waste content comprising at least one organic phase are preserved over the period and under the mentioned temperature and pressure conditions. In particular, no formation of aggregates is observed for a period comprised between 1 and 7 days, in particular of about 3 days.

This stability gives the possibility of storing the emulsion formed in step a) or b), notably in order to conduct the possible TOD measurements before the application of step c).

It is further observed, notably in the case when a non-ionic surfactant is used, and in particular a polysorbate and/or a nonylphenol ethoxylate, is sufficient to provide low kinetic energy (i.e. low stirring), to the degraded emulsion in order to again find the initial properties of homogeneity and of average drop size of the emulsion. A low occurrence of foam is also observed when a non-ionic surfactant is used, as compared with the use of anionic or cationic surfactants.

As regards the hydrothermal oxidation step c) under sub-critical starting conditions and its preferred embodiments, reference may be made to applications WO 02/20414 or WO 2012/095391 which detail these aspects.

In a particular embodiment, the oxidizer used during this step c) does not comprise any hydrogen peroxide (H₂O₂). Preferably, it exclusively consists of dioxygen (O₂) or air, or a mixture thereof.

In a particular embodiment, the effluent treated at the outlet of the oxidation reactor is subject to expansion, which generates gases on the one hand essentially comprising CO₂, and liquid water on the other hand. The thereby obtained liquid water at the end of the hydrothermal oxidation step c) may undergo subsequent optional treatments, for example demineralization, notably by reverse osmosis.

Thus, the treated effluent may be recycled as a source of water for the aqueous phase of step a), or the optional adjustment step b).

Optionally, the method according to the invention also comprises steps for analyzing other parameters such as the halogen content, preferably carried out between steps a) and b), so that step b) may also be used for adjusting the halogen content for example.

The present invention also relates to a facility adapted for applying the method according to the invention, comprising:
a mixer (1), preferably a high shear mixer, adapted for receiving an aqueous phase and the waste to be treated for preparing the emulsion; and
a hydrothermal oxidation reactor (6), preferably tubular and comprising several points for injecting the oxidizer, for achieving hydrothermal oxidation of the emulsion under sub-critical or supercritical starting conditions, preferably sub-critical conditions.

Advantageously, the facility further comprises a storage tank (2) for the emulsion adapted for receiving and storing the emulsion, the tank being located between the mixer (1) and the hydrothermal oxidation reactor (6), the storage tank being adapted for receiving the emulsion to be treated batch-wise and giving the possibility of coupling the batch-wise manufacturing of the emulsion to a continuous hydrothermal oxidation process.

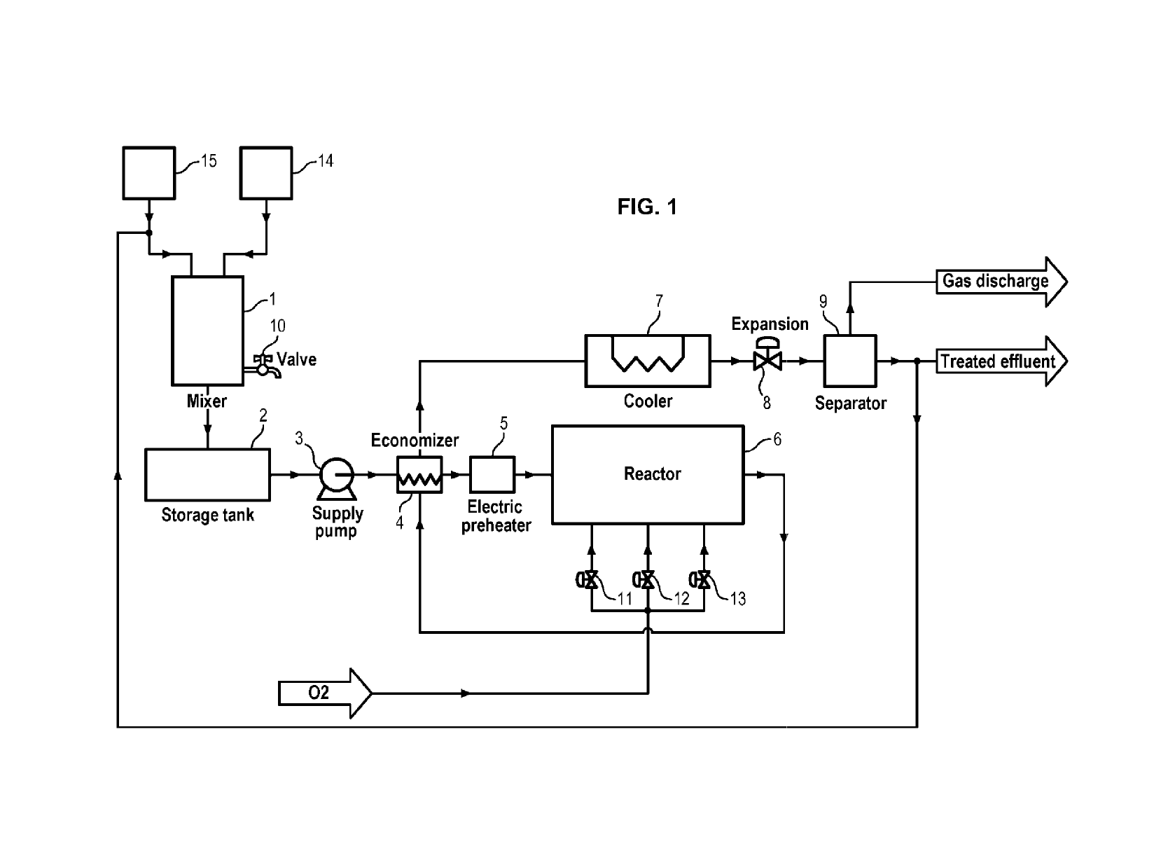

FIG. 1 illustrates a particular embodiment of the facility according to the invention. Thus, in FIG. 1, the facility comprises:
a mixer (1), preferably a high shear mixer receiving at the inlet the aqueous phase comprising the surfactant and the waste comprising at least one organic phase;
a storage tank (2) for the emulsion adapted for receiving and storing the emulsion at the outlet of the mixer;
a supply pump (3) laid out at the outlet of the storage tank in order to sample the emulsion of the storage tank and to inject it towards a heat exchanger (4) of the treatment facility;
a heat exchanger (4) used for pre-heating the emulsion obtained at the end of step a) or b);
an electric pre-heater (5);
a hydrothermal oxidation reactor (6), preferably tubular and comprising several injection points (preferably three injection points) for the oxidizer, the oxidizer preferably being dioxygen;
a cooler (7);
a first expansion valve (8);
a separator (9).

The mixer (1) advantageously comprises a manual tap or a valve (10) giving the possibility of taking an emulsion sample in order to notably measure the TOD of said emulsion for optionally adjusting it to a suitable value. Alternatively, the tap or the valve may be located on an online sampling loop. The aqueous phase is optionally stored in the tank (15), while the waste to be treated is stored in the tank (14). The tanks (14) and (15) are connected to the inlets of the mixer (1).

The storage tank (2) gives the possibility of receiving the emulsion to be treated batch-wise (batches) and of continuously supplying the supply pump (3). Thus, the storage tank gives the possibility of coupling a batch-wise manufacturing process (batch) of the emulsion which will be used as a reagent to the hydrothermal oxidation reaction, to a continuous hydrothermal oxidation process.

The supply pump (3) injects under pressure the emulsion in the heat exchanger (4). The emulsion passes from atmospheric pressure to a pressure preferably comprised between 221 and 300 bars. At this stage, the emulsion is in the liquid state.

The heat exchanger (4) gives the possibility of heating the emulsion at the outlet of the pump (3) by heat exchange with the effluent treated at the outlet of the reactor (6). The temperature of the emulsion is then comprised between 150 and 374° C., preferably comprised between 250° C. and 340° C. The exchanger transfers a portion of the heat of the supercritical fluid obtained at the outlet of the hydrothermal oxidation reactor (6) to the emulsion used as a reagent of the hydrothermal oxidation reaction. Such a device allows minimization of the overall energy consumption of the process.

The electric heater (5) gives the possibility of heating the emulsion during the transient starting phase of the process when the effluent at the outlet of the reactor has not attained a sufficient temperature for bringing the emulsion to a temperature comprised between 150 and 374° C., preferably comprised between 250° C. and 340° C.

The reactor (6) receives at the input the emulsion from the exchanger (4) or from the electric heater (5).

The reactor (6) receives at the input the emulsion on the one hand and pressurized oxygen on the other hand necessary for the hydrothermal oxidation reaction. The emulsion circulates in the reactor. The oxygen is injected in different points of the reactor (preferably 3 points) along the circulation path of the effluent.

According to an alternative of the invention, the collected effluent at the outlet of the reactor (6) preferably has a TOD of less than 300 mg/L, and is at a temperature comprised between 374° C. and 600° C., preferably between 500° C. and 600° C. The effluent is then injected into the heat exchanger (4) for heating the emulsion at the inlet of the reactor (6).

The effluent at the outlet of the exchanger (4), which is then typically at a temperature comprised between 200° C. and 250° C., is cooled by a cooler (7) down to a temperature for example comprised between 15° C. and 100° C., preferably 15° C. and 30° C. The cooler advantageously gives the possibility of giving value to the heat energy of the effluent by for example using it for generating electricity or for heating (steam or other network).

And then, the thereby obtained cooled effluent at the outlet of the cooler (7) is subject to an expansion by means of the expansion valve (8). The effluent then passes under atmospheric pressure. It appears in the form of a mixture of gas and of liquid, the gaseous phase notably comprising CO₂ and O₂, optionally mixed with N₂, and the liquid essentially consists of water not containing any longer organic material. The liquid effluent obtained at this treatment stage for example has a COD of less than 300 mg/L, preferably less than 100 mg/L, still preferably less than 50 mg/L.

The separator (9) gives the possibility of separating the gas phase from the liquid phase. According to an advantageous alternative, a portion of the liquid phase is sampled at the outlet of the separator so as to be injected at the inlet of the mixer (1) in order to adjust the amount of water in the emulsion. Said liquid phase optionally is subject to further treatment in order to adjust the quality of the water of the liquid phase.

The valves 11, 12 and 13 control the flow rate of pressurized dioxygen (oxidizer), optionally in a supercritical phase, injected into the reactor (6) in each of the three injection points.

The method and the facility according to the invention thus give the possibility of extending the field of application of the hydrothermal oxidation process to the treatment of wastes comprising at least one organic phase under sub-critical starting conditions, and this by means of a method which does not require any particular adaptation of the method per se but exclusively a preparation of the effluent. The present invention allows quite particular improvement in the safety and the control of the process in terms of handling the temperature profile in the reactor(s), notably by means of a control of the TOD of the reagent (emulsion) used in the hydrothermal oxidation reaction. The present invention further gives the possibility of an economical gain as compared with the process described by Sanchez-Oneto.

### EXAMPLES

The present invention is illustrated by the examples below, which however cannot be considered as limiting.

The method is conducted in a facility as described in FIG. 1.

### Example 1

### Manufacturing of Emulsions According to the Invention and Comparative Examples

Waste of Used Hydrocarbon Type

The waste to be treated is an oil of the oil-change type for a transportation vehicle. It essentially contains compounds based on the elements C, H and O (waste of the used hydrocarbon type), and is single phase.

Each test deals with 50 g samples.

The surfactant is mixed with demineralized water. The thereby obtained aqueous phase comprises 1% by weight of surfactant, based on the total weight of the aqueous phase. And then the waste to be treated is gradually incorporated into said aqueous phase comprising the surfactant in a high shear mixer of the Ultra Turrax® brand, marketed by IKA. The mixture is sheared for 1 to 5 minutes.

Oil-in-water emulsions are then obtained.

The amounts of water and of waste are such that the obtained emulsions consist of 50% by weight of aqueous phase, and 50% of effluent to be treated. As indicated above, the aqueous phase comprises 1% by weight of surfactant. Thus, for each test, 24.75 g of demineralized water, 0.25 g of surfactant and 25 g of waste to be treated are added.

Three different surfactants were tested:
a cationic surfactant, tetradecyltrimethylammonium bromide (TTAB);
an anionic surfactant, sodium laurylsulfate; and
a non-ionic surfactant, Polysorbate 80 or TWEEN® 80.

In parallel, tests were also conducted in the absence of any surfactant. In this case, the aqueous phase consists of 100% of demineralized water, and the final emulsion comprises 50% by weight of demineralized water and 50% by weight of waste to be treated.

In the absence of any surfactant, demixing is observed very rapidly (in less than 1 h30 mins). The emulsion is therefore not stable in the absence of a surfactant.

In the tests for which a surfactant is used, the obtained emulsion has a TOD comprised between 850 g/L and 950 g/L.

A dilution step by adding demineralized water is therefore necessary in order to obtain a TOD with a desired value (comprised between 100 and 250 g/L).

Demixing of the emulsion following the dilution step with the cationic surfactant is observed.

Stable emulsions and not adhering to the walls of the reactors are obtained, even after dilution, with the surfactants TWEEN® 80 and sodium laurylsulfate. The average diameter of the drops in the obtained emulsions is of about 1 μm.

Waste of Toxic Industrial Waste Type

The waste is a toxic industrial diphasic waste. Its organic phase essentially contains compounds based on the elements C, H and O (a waste of the used hydrocarbon type), and appears in a decanted form.

The decanted waste was separated into an aqueous phase and an organic phase.

In this case, the waste to be treated is formed by the organic phase.

Each test deals with 50 g sample.

The surfactant is directly mixed with the aqueous phase after separating both phases of the waste. The thereby obtained aqueous phase comprises 1% by weight of the surfactant, based on the total weight of the aqueous phase. And then, the organic phase of the waste to be treated is gradually incorporated to said aqueous phase comprising the surfactant in a high shear mixer of the Ultra Turrax® brand, marketed by IKA. The mixture is sheared for 1 to 5 minutes.

The amounts of each phase are such that the obtained emulsions consist of 50% by weight of aqueous phase and 50% of organic phase. As indicated above, the aqueous phase comprises 1% by weight of surfactant. Thus, for each test, 24.75 g of isolated aqueous phase from the waste to be treated, 0.25 g of surfactant and 25 g of organic phase isolated from the waste to be treated are added.

Three different surfactants were tested:
a cationic surfactant, tetradecyltrimethylammonium bromide (TTAB);
an anionic surfactant, sodium laurylsulfate; and
a non-ionic surfactant, Polysorbate 80 or TWEEN® 80.

Oil-in-water emulsions are then exclusively obtained when an anionic or non-ionic surfactant is used. No emulsion forms with a cationic surfactant.

With sodium laurylsulfate, demixing is observed very rapidly (in less than 1 h30 mins). The emulsion is therefore not stable with an anionic surfactant.

The obtained emulsions (sodium laurylsulfate and TWEEN® 80) have a TOD comprised between 850 g/L and 1,050 g/L.

A dilution step by adding demineralized water is therefore necessary in order to obtain a TOD of a desired value (comprised between 100 and 250 g/L).

Stable emulsions and not adhering to the walls of the reactors are obtained with TWEEN® 80, even after dilution. The average diameter of the drops in the obtained emulsions is comprised between 0.5 μm and 1 μm.

Waste of Non-Recoverable Hydrocarbon Type

The waste to be treated is a single phase waste from the oil industry which is non-recoverable. Its organic phase essentially contains compounds based on the elements C, H, O and S (waste of the crude oil type).

Each test deals with 50 g samples.

The surfactant is mixed with demineralized water. The thereby obtained aqueous phase comprises 0%, 1%, 2% or 5% by weight, based on the total weight of the aqueous phase, of the surfactant. And then, the waste is gradually incorporated to said aqueous phase comprising the surfactant in a high shear mixer of the Ultra Turrax® brand, marketed by IKA. The mixture is sheared for 1 to 5 minutes.

The amounts of water and the waste are such that the obtained emulsions consists of 70% by weight of aqueous phase and 30% of effluent to be treated. As indicated above, the aqueous phase comprises 0%, 1%, 2% or 5% by weight by weight of surfactant.

Three different non-ionic surfactants were tested:
Polysorbate 80 or TWEEN® 80 (surfactant A);
Tergitol® NP7, a surfactant from the family of Nonylphenol Ethoxylates (surfactant B); and
Polysorbate 20 or TWEEN® 20 (surfactant C).

The obtained emulsions have a TOD comprised between 225 g/L and 265 g/L. Stable emulsions and not adhering to the walls of the reactors are obtained in every case.

| | | TOD | | |
|---|---|---|---|---|
| Sample | Surfactant | (in g/L) | Characteristics of the emulsion | Stability |
| E4 | /(0%) | 230 | The average diameter of the drops is 5 | Not very |
| | | | μm. Many aggregates and solid clusters | stable, non- |
| | | | are further observed with a diameter | reproducible |
| | | | comprised between 10 and 50 μm. | |
| E5 | A (5%) | 235 | The average diameter of the drops is | Stable |
| | | | comprised between 3 and 4 μm. | |
| | | | Aggregates and solid clusters are further | |
| | | | observed, but less than in the emulsion | |
| | | | E4. | |
| E6 | B (1%) | 225 | The average diameter of the drops is 3 | Stable |
| | | | μm. Aggregates and solid clusters are | |
| | | | further observed but less than in the | |
| | | | emulsion E5. | |
| E7 | B (2%) | 250 | The average diameter of the drops is | Stable |
| | | | comprised between 2 and 3 μm. | |
| | | | Aggregates and solid clusters are further | |
| | | | observed, but less than in the emulsion | |
| | | | E6. | |
| E8 | C (1%) | 245 | The average diameter of the drops is 1 | Stable |
| | | | μm. Aggregates and solid clusters are | |
| | | | further observed but less than in the | |
| | | | emulsions E4 to E7. | |
| E9 | C (2%) | 265 | The average diameter of the drops is less | Stable |
| | | | than 1 μm. Aggregates and solid clusters | |
| | | | are further observed, but less than in the | |
| | | | emulsion E8. | |

Without any surfactant, the obtained emulsion is not stable. Moreover, it is noted that under these conditions, only emulsion E9 requires additional dilution in order to obtain a TOD of less than 250 g/L.

### Example 2

### Application of the Hydrothermal Oxidation Reaction on the Obtained Emulsions According to the Invention

The waste to be treated is a single-phase waste from the oil industry which is non-recoverable (a waste similar to the third waste of example 1). Its organic phase essentially contains compounds based on the elements C, H, O and S (waste of the crude petroleum type).

An industrial treatment example of this waste was carried out on a hydrothermal oxidation unit under sub-critical starting conditions with a capacity of 100 kg/h.

The making of the emulsion took place as follows:

475 L of water were loaded into a storage tank equipped with a high shear mixer. To this volume were added 5 L of surfactant TERGITOL 15-S-7. In this aqueous phase is gradually incorporated 70 L of single-phase waste from the oil industry and non-recoverable. The mixture is stirred with the high shear mixer of the SILVERSON® brand for 1 h. The TOD of the obtained mixture is 60 g/L.

A doping phase is then carried out by means of a second waste containing alcohols (isopropanol and butanol) in an aqueous phase and perfectly soluble. Thus 450 L of dopant are added to the mixture and the whole is stirred for 12 h. The TOD of the obtained mixture is 177 g/L.

This emulsion is then used for continuously supplying the hydrothermal oxidation facility under sub-critical starting conditions.

The emulsion is pre-heated at the inlet of the reactor, and then injected into the reactor where multiple injection of oxygen is achieved in three points increasingly on the downstream side. The first injection causes the medium to rise to a temperature T1, the second one to a temperature T2 and the third one to a temperature T3, according to an increasing temperature profile (without any temperature decrease). The TOD of the flow at the outlet of the reactor, the so-called “final TOD” was measured.
initial TOD=177 g/L

Injection temperature: 305° C.
T1=365° C.
T2=445° C.
T3=580° C.

Efficient conversion of the emulsion is obtained, with a final TOD equal to 27 mg/l, but with control of the rise in temperature.

1. A method for treating wastes comprising at least one organic phase, said method comprising the following successive steps:
a) preparing an oil-in-water emulsion with a controlled TOD from a waste to be treated comprising at least one organic phase, by mixing in a mixer, preferably with high shear, said waste with an aqueous phase;
b) optionally adjusting the TOD of the emulsion obtained in step a);
c) hydrothermal oxidation under sub-critical or supercritical starting conditions of the thereby obtained emulsion,
the waste to be treated comprising at least one organic phase:
either consisting of a single organic phase,
or being a multiphase waste comprising at least one organic phase, appearing in a decanted form or as an emulsion comprising aggregates or drops with an average or apparent diameter greater than 1 mm.

2. The method according to claim 1, wherein the emulsion obtained at the end of step a) or b) has an average drop size of less than 1,000 μm.

3. The method according to claim 1, wherein the TOD of the oil-in-water emulsion obtained at the end of step b) is comprised between 20 and 400 g/L.

4. The method according to claim 1, wherein the aqueous phase of the emulsion in step a) comprises at least one surfactant, representing less than 10% by weight, based on the total weight of the aqueous phase.

5. The method according to claim 4, wherein the surfactant is non-ionic, preferably selected from among polysorbates and nonylphenol ethoxylates.

6. The method according to claim 4, wherein the surfactant is mixed with the aqueous phase, and then the waste to be treated comprising at least one organic phase is gradually incorporated in a mixer to said aqueous phase comprising the surfactant, leading to the formation of the oil-in-water emulsion.

7. The method according to claim 1, wherein the steps a) and b) are conducted according to a batch-wise method.

8. The method according to claim 1, wherein the oxidizer used during step c) exclusively consists of dioxygen (O₂) or air, or a mixture thereof.

9. A facility adapted for applying the method according to claim 1, comprising:
a high shear mixer, adapted for receiving an aqueous phase and the waste to be treated in order to prepare the emulsion; and
a hydrothermal oxidation reactor for achieving hydrothermal oxidation of the emulsion under sub-critical or supercritical starting conditions.

10. The facility according to claim 9, wherein the facility further comprises a storage tank for the emulsion adapted for receiving and storing the emulsion, the tank being located between the mixer and the hydrothermal oxidation reactor the storage tank being adapted for receiving the emulsion to be treated batch-wise and giving the possibility of coupling the batch-wise manufacturing of the emulsion to a continuous hydrothermal oxidation process.
